(19) United States
(12) Patent Application Publication
(10) Pub. No.: US 2019/0332934 A1
(43) Pub. Date: Oct. 31, 2019

(54) APPARATUS AND METHOD FOR MANUFACTURING INTEGRATED CIRCUIT INCLUDING CLOCK NETWORK

(71) Applicant: BAUM CO. LTD., Seongnam-si (KR)

(72) Inventor: In Hak HAN, Yuseong-gu (KR)

(21) Appl. No.: 16/121,110

(22) Filed: Sep. 4, 2018

(30) Foreign Application Priority Data
Apr. 27, 2018 (KR) 10-2018-0049407

(51) Int. Cl. G06N 3/08

(52) U.S. Cl. CPC G06N 3/08

(57) ABSTRACT

Provided is an apparatus for manufacturing an integrated circuit including a clock network, the apparatus including a preprocessor configured to obtain at least one input parameter and an input netlist including the clock network; a neural network interface configured to provide the input netlist and the at least one input parameter to at least one artificial neural network (ANN) that has been trained based on a plurality of netlists and a plurality of parameters, and receive, from the at least one ANN, at least one output parameter that defines the clock network, wherein the plurality of netlists and the plurality of parameters correspond to a plurality of sample clock networks; and a power calculator configured to calculate power consumption of the clock network, based on the at least one output parameter.

### CROSS-REFERENCE TO RELATED APPLICATION

This application claims the benefit of Korean Patent Application No. 10-2018-0049407, filed on Apr. 27, 2018, in the Korean Intellectual Property Office, the disclosure of which is incorporated herein in its entirety by reference.

### BACKGROUND

### 1. Field

The present disclosure relate to a clock network, and more particularly, to an apparatus and method for manufacturing an integrated circuit including a clock network.

### 2. Description of the Related Art

In an integrated circuit, a clock network or a clock tree may distribute a clock signal generated by a clock generator. A clock signal is a signal that is constant or oscillates with a variable cycle and may have skew, jitter, or duty cycle characteristics, or the like. Performance of an integrated circuit may depend on the characteristics of a clock signal. A clock network may require high power consumption due to repeatedly oscillating clock signals, and for example, the power consumption of the clock network may be about 40% or more of the power consumption of the integrated circuit.

In a process of manufacturing an integrated circuit, e.g., in a process of designing the integrated circuit, when power consumption of a clock network is calculated or measured after the clock network is fixed, the power consumption of the clock network is unknown in previous processes where the clock network is not fixed, and thus, blocks included in the integrated circuit may be designed such that they include an unnecessary power margin, and optimal performance of the integrated circuit may not be achieved. In addition, overhead is increased due to redesigning of the integrated circuit, and thus, a design time of the integrated circuit may be significantly extended, and the time to market of the integrated circuit may be delayed. Accordingly, there is a demand for accurate estimation of power consumption of a clock network before the clock network is fixed in the process of manufacturing an integrated circuit.

### SUMMARY

Provided are an apparatus and method for manufacturing an integrated circuit including a clock network by accurately estimating power consumption of the clock network.

Additional aspects will be set forth in part in the description which follows and, in part, will be apparent from the description, or may be learned by practice of the presented embodiments.

In accordance with an aspect of the disclosure, an apparatus for manufacturing an integrated circuit including a clock network includes a preprocessor configured to obtain at least one input parameter and an input netlist including the clock network; a neural network interface configured to provide the input netlist and the at least one input parameter to at least one artificial neural network (ANN) that has been trained based on a plurality of netlists and a plurality of parameters, and receive, from the at least one ANN, at least one output parameter that defines the clock network, wherein the plurality of netlists and the plurality of parameters correspond to a plurality of sample clock networks; and a power calculator configured to calculate power consumption of the clock network, based on the at least one output parameter.

The apparatus may further include a layout data generator configured to generate layout data that defines the integrated circuit, wherein the layout data includes information about a mask to be used in manufacturing the integrated circuit.

The power calculator may include a capacitance calculator configured to calculate total capacitance of buffer cells and capacitances of clock gating cells of the clock network; a switching power calculator configured to calculate switching power of the clock network, based on the total capacitance and the capacitances; and an internal power calculator configured to calculate internal power of the buffer cells and the clock gating cells of the clock network, based on an input transition time, the total capacitance, and the capacitances.

The switching power calculator may be further configured to obtain information about active periods in which the clock gating cells are enabled, from a function simulation result of the integrated circuit, and calculate switching power of each of the clock gating cells, based on the capacitances and the active periods.

The internal power calculator may be further configured to obtain information about active periods in which the clock gating cells are enabled, from a function simulation result of the integrated circuit, and calculate the internal power of the clock gating cells, based on the capacitances and the active periods.

In accordance with another aspect of the disclosure, a method for manufacturing an integrated circuit including a clock network includes providing at least one input parameter and an input netlist including the clock network to at least one ANN that has been trained based on a plurality of netlists and a plurality of parameters, wherein the plurality of netlists and the plurality of parameters correspond to a plurality of sample clock networks; receiving, from the at least one ANN, at least one output parameter that defines the clock network; and calculating power consumption of the clock network, based on the at least one output parameter.

The method may further include generating layout data that defines the integrated circuit; and manufacturing the integrated circuit by using at least one mask made based on the layout data.

The at least one input parameter may include a first input parameter including at least one of a target skew, a sink transition time, an area, a utilization factor, an aspect ratio, and a number of sinks of a clock gating cell, the providing of the input netlist and the at least one input parameter may include providing the first input parameter and a number of clock gating cells in the input netlist to a first ANN, and the receiving of the at least one output parameter may include receiving, from the first ANN, the at least one output parameter including an estimated number of the clock gating cells.

The at least one input parameter may further include a second input parameter including at least one of a target skew, a sink transition time constraint, a buffer transition time constraint, an area, an utilization factor, an aspect ratio, and an average of a number of sinks of clock gating cells, the providing of the input netlist and the at least one input parameter may further include providing the second input parameter and the estimated number of the clock gating cells to a second ANN, and the receiving of the at least one output parameter may further include receiving, from the second ANN, the at least one output parameter including an estimated number of buffer cells.

The at least one input parameter may further include a third input parameter including at least one of a sink transition time constraint, a buffer transition time constraint, an area, an utilization factor, and an aspect ratio, the providing of the input netlist and the at least one input parameter may further include providing the third input parameter, the estimated number of the clock gating cells, and the estimated number of the buffer cells to a third ANN, and the receiving of the at least one output parameter may further include receiving, from the third ANN, the at least one output parameter including estimated wire loads of the buffer cells.

The at least one input parameter may further include a fourth input parameter including at least one of a sink transition time constraint, an area, an utilization factor, an aspect ratio, and a number of sinks of a clock gating cell, the providing of the input netlist and the at least one input parameter may further include providing the fourth input parameter and the estimated number of the clock gating cells to a fourth ANN, and the receiving of the at least one output parameter may further include receiving, from the fourth ANN, the at least one output parameter including estimated wire loads of the clock gating cells.

The calculating of the power consumption may include calculating power consumption of buffer cells of the clock network, wherein the calculating of the power consumption of buffer cells includes calculating total capacitance of the buffer cells; calculating switching power of the buffer cells, based on the total capacitance and a positive voltage supply; and calculating internal power of the buffer cells, based on the total capacitance and an input transition time.

The calculating of the power consumption may include calculating power consumption of clock gating cells of the clock network, wherein the calculating of the power consumption of the clock gating cells includes calculating capacitances of the clock gating cells; obtaining active periods in which the clock gating cells are enabled, from a function simulation result of the integrated circuit; and calculating switching power and internal power of each of the clock gating cells, based on the capacitances and the active periods.

In accordance with another aspect of the disclosure, there is provided a non-transitory computer-readable storage medium storing program instructions which, when executed by at least one processor, perform operations of manufacturing an integrated circuit including a clock network, the operations including providing at least one input parameter and an input netlist including the clock network to at least one artificial neural network (ANN) that has been trained based on a plurality of netlists and a plurality of parameters, wherein the plurality of netlists and the plurality of parameters correspond to a plurality of sample clock networks; receiving, from the at least one ANN, at least one output parameter that defines the clock network; and calculating power consumption of the clock network, based on the at least one output parameter.

The operations may further include generating layout data that defines the integrated circuit; and extracting data for making at least one mask to be used in the manufacturing of the integrated circuit from the layout data.

The calculating of the power consumption of the clock network may include obtaining active periods in which clock gating cells of the clock network are enabled, from a function simulation result of the integrated circuit; and calculating switching power and internal power of each of the clock gating cells, based on the active periods.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating an apparatus for manufacturing an integrated circuit, according to an exemplary embodiment;

FIG. 2 is a diagram of an example of at least one artificial neural network (ANN) of FIG. 1, according to an exemplary embodiment;

FIG. 3 is a flowchart of a method for manufacturing an integrated circuit, according to an exemplary embodiment;

FIG. 4 is a flowchart illustrating a method for estimating power consumption of a clock network, according to an exemplary embodiment;

FIG. 5 is a diagram illustrating an example of a clock network, according to an exemplary embodiment;

FIG. 6 is a block diagram illustrating an example of a neural network system of FIG. 1, according to an exemplary embodiment;

FIG. 7 is a block diagram illustrating an example of a power calculator of FIG. 1, according to an exemplary embodiment;

FIGS. 8 and 9 are flowcharts respectively illustrating methods of calculating power consumption of a clock network, according to exemplary embodiments;

FIG. 10 is a block diagram of a computing system, according to an exemplary embodiment; and

FIG. 11 is a block diagram of a storage medium, according to an exemplary embodiment.

### DETAILED DESCRIPTION

Hereinafter, the disclosure now will be described more fully with reference to the accompanying drawings, in which illustrative embodiments of the disclosure are shown. The embodiments are provided so that this disclosure will be thorough and complete, and will fully convey the scope of the disclosure to those of ordinary skill in the art. As the disclosure allows for various changes and numerous embodiments, particular embodiments will be illustrated in the drawings and described in detail in the written description. However, this is not intended to limit the disclosure to particular embodiments, and it is to be appreciated that all changes, equivalents, and substitutes that do not depart from the spirit and technical scope of the disclosure are encompassed in the disclosure. Like reference numerals in the drawings denote like or similar elements throughout the specification. In the drawings, the dimension of structures may be exaggerated or reduced for clarity of the disclosure.

The terms used in the present specification are merely used to describe particular embodiments, and are not intended to limit the disclosure. Throughout the specification, a singular form may include plural forms, unless there is a particular description contrary thereto. Also, terms such as “comprise” or “comprising” are used to specify existence of a recited feature, a number, a process, an operation, a component, a part, and/or groups thereof, not excluding the existence of one or more other recited features, one or more other numbers, one or more other processes, one or more other operations, one or more other components, one or more other parts, and/or groups thereof.

While terms “first” and “second” may be used to describe various components, it is obvious that the components are not limited to the terms “first” and “second”. The terms “first” and “second” are used only to distinguish between each component. For example, a first component may indicate a second component or a second component may indicate a first component without conflicting with the scope of the disclosure.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

As used herein, the term “and/or” includes any and all combinations of one or more of the associated listed items. Expressions such as “at least one of,” when preceding a list of elements, modify the entire list of elements and do not modify the individual elements of the list.

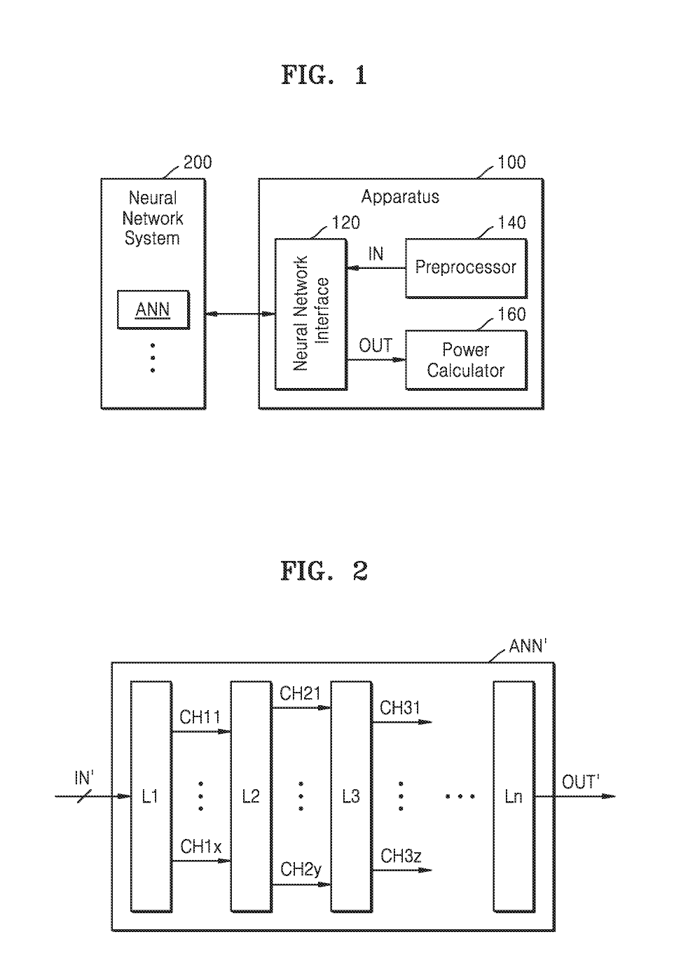

FIG. 1 is a block diagram illustrating an apparatus 100 for manufacturing an integrated circuit according to an exemplary embodiment. As illustrated in FIG. 1, the apparatus 100 may communicate with a neural network system 200, and may estimate power used by a clock network included in the integrated circuit, by using at least one artificial neural network (ANN) included in the neural network system 200. In the present specification, the clock network that is included in the integrated circuit and whose power consumption is to be estimated may also be referred to as “object clock network”.

The ANN may indicate a computing system based on a biological neural network that constitutes an animal brain, or a method performed by the computing system. Unlike an algorithm according to the related art, e.g., rule-based programming, which performs a task according to a predefined condition, the ANN may learn to perform the task, in consideration of a plurality of samples (or examples). The ANN may have a structure in which artificial neurons (or neurons) are connected, and connections between the neurons may each be referred to as a synapse. A neuron may process a received signal, and may transmit the processed signal to another neuron via a synapse. An output from the neuron may be referred to as “activation”. A neuron and/or a synapse may have a variable weight, and strength of the signal processed by the neuron may be increased or decreased based on the weight. In particular, a weight related to each neuron may be referred to as a bias. An example of the ANN will be described below with reference to FIG. 2.

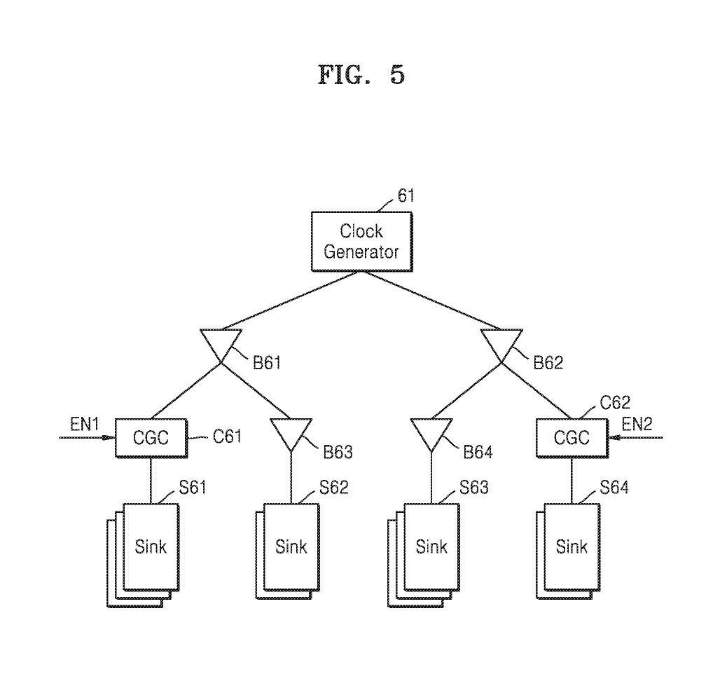

The at least one ANN included in the neural network system 200 may be trained by a plurality of netlists and a plurality of parameters which correspond to a plurality of sample clock networks. The plurality of netlists may include a pre-clock tree synthesis (pre-CTS) netlist and a post-CTS netlist, wherein the pre-CTS netlist indicates a netlist of integrated circuits used in a CTS for the sample clock networks, and the post-CTS netlist indicates a netlist of integrated circuits after the CTS is completed. The pre-CTS netlist may be a gate-level netlist obtained after logic synthesis or placement of the integrated circuits. The post-CTS netlist may define a buffer cell (e.g., a buffer cell B61 of FIG. 5) and a clock gating cell (e.g., a clock gating cell C61 of FIG. 5) which are to be included in the clock network due to the CTS, and may define wires that interconnect the cells. Each of the wires may include a conductive pattern such as a pattern of a metal layer, and may include a via that interconnects conductive patterns of different layers. In some embodiments, the pre-CTS netlist may define at least one clock gating cell, and the post-CTS netlist may define a number of clock gating cells, the number being different from the pre-CTS netlist by adding or removing a clock gating cell due to the CTS.

The plurality of parameters of the plurality of sample clock networks may include parameters (or design parameters) that define requirements of the plurality of sample clock networks. For example, the plurality of parameters may include a target skew and a transition time constraint of a clock signal, an entire area of a chip, a utilization factor, and an aspect ratio.

As will be described below, to estimate power consumption of a target clock network that is a clock network of the integrated circuit, input data IN provided to the neural network system 200 (or the at least one ANN) may include a pre-CTS netlist and at least one parameter of the target clock network, and output data OUT provided by the neural network system 200 (or the at least one ANN) may include at least a part of information defining the target clock network, e.g., a part of information included in a post-CTS netlist. Accordingly, data of a structure of the target clock network, the data being required to estimate the power consumption of the target clock network, may be estimated by using the at least one ANN, based on initial information about the clock network, and the power consumption of the target clock network may be calculated based on the estimated data. Accordingly, the estimated power consumption of the target clock network may have high accuracy. A test result shows that the power consumption of the target clock network which is estimated according to exemplary embodiments has a maximum deviation of 3.6% and an average deviation of 2.1% relative to a real power consumption of the target clock network.

The apparatus 100 may be a random system that estimates the power consumption of the target clock network so as to manufacture the integrated circuit according to exemplary embodiments. In some embodiments, the apparatus 100 may be a computing system including at least one processor and a memory. As a non-limited example, the apparatus 100 may be a stationary computing system such as a desktop computer, a server, or the like or may be a mobile computing system such as a laptop computer, a smartphone, or the like. As illustrated in FIG. 1, the apparatus 100 may include a neural network interface 120, a preprocessor 140, and a power calculator 160, and each of the neural network interface 120, the preprocessor 140, and the power calculator 160 may be implemented as a logic block implemented via logic synthesis, a software block performed by a processor, or a combination thereof. In some embodiments, each of the neural network interface 120, the preprocessor 140, and the power calculator 160 may be referred to as a procedure that is a group of a plurality of instructions executable by a processor, and may be stored in a memory to be accessed by the processor.

The neural network interface 120 may communicate with the neural network system 200, and may provide communication interface with the neural network system 200 to other components of the apparatus 100, i.e., the preprocessor 140 and the power calculator 160. For example, the neural network interface 120 may provide input data IN provided from the preprocessor 140 to the neural network system 200, and may provide output data OUT received from the neural network system 200 to the power calculator 160. In some embodiments, unlike to what is illustrated in FIG. 1, the apparatus 100 in some embodiments may be included in the at least one ANN, and the neural network interface 120 may not be provided.

The preprocessor 140 may obtain a netlist of the target clock network (or a netlist including the target clock network) and at least one parameter, and may provide input data IN including the obtained netlist and the at least one parameter to the neural network system 200 via the neural network interface 120. In some embodiments, as described above, the netlist included in the input data IN may be the pre-CTS netlist of the target clock network, and the at least one parameter included in the input data IN may include the parameter defining the requirements of the target clock network. In some embodiments, the preprocessor 140 may receive the netlist of the target clock network and the at least one parameter from an outer source of the apparatus 100, and in some embodiments, the preprocessor 140 may read the netlist of the target clock network and the at least one parameter that are stored in a storage included in the apparatus 100. In the present specification, the netlist included in the input data IN may be referred to as an input netlist, and the at least one parameter included in the input data IN may be referred to as an input parameter.

The power calculator 160 may receive the output data OUT from the neural network interface 120, and may calculate the power consumption of the target clock network, based on the output data OUT. In some embodiments, as described above, the output data OUT may include the at least one parameter as at least a part of the information included in the post-CTS netlist of the target clock network. The power calculator 160 may accurately calculate the power consumption, based on the at least one parameter included in the output data OUT, with low calculation complexity. In the present specification, the at least one parameter included in the output data OUT may be referred to as an output parameter. An example of the power calculator 160 will be described below with reference to FIG. 7 or the like.

FIG. 2 is a diagram of an example of the at least one ANN of FIG. 1, according to an exemplary embodiment. As described above with reference to FIG. 1, an ANN′ of FIG. 2 may be trained based on a plurality of pieces of information corresponding to a plurality of sample clock networks, and as illustrated in FIG. 2, the ANN′ may generate output data OUT′ from input data IN′.

Referring to FIG. 2, the ANN′ may include first, second, third, and nth layers L1, L2, L3, . . . , and Ln, and an output from a layer may be input to a subsequent layer via at least one channel. For example, the first layer L1 may process the input data IN′ and may then provide an output to the second layer L2 via a plurality of channels CH11 . . . CH1x, and the second layer L2 may provide an output to the third layer L3 via a plurality of channels CH21 . . . CH2y. Finally, the nth layer Ln may output the output data OUT′, and the output data OUT′ may include at least one value associated with the input data IN′. The number of channels via which the respective outputs from the first, second, third, and nth layers L1, L2, L3, . . . , and Ln are delivered may be equal to or different from each other. For example, the number of the channels CH21 . . . CH2y of the second layer L2 and the number of channels CH31 . . . CH3z of the third layer L3 may be equal to or different from each other.

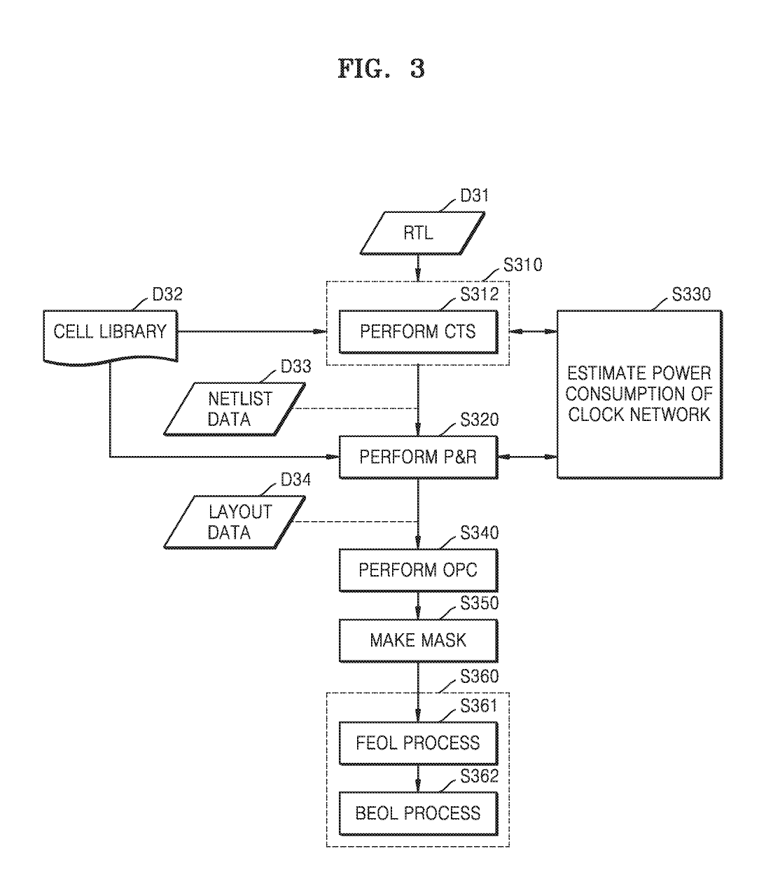

FIG. 3 is a flowchart of a method for manufacturing an integrated circuit according to an exemplary embodiment. As illustrated in FIG. 3, the method for manufacturing an integrated circuit according may include operation S330 of estimating power consumption of a clock network (or a target clock network), and the estimated power consumption may be used in operation S310 of logic synthesis and/or operation S320 of performing placement and routing. For example, operation S330 of FIG. 3 may be performed by the apparatus 100 of FIG. 1.

A cell library D32 may include information about a plurality of cells, e.g., function information, characteristic information, layout information, or the like. A cell refers to a unit of a layout included in an integrated circuit, and the integrated circuit may include various cells. In some embodiments, cells may be referred to as standard cells, and may include an architecture conforming to a predefined standard, e.g., a certain height and a pair of power rails at opposite boundaries.

The clock network may include the cells stored in the cell library D32, e.g., a buffer cell (refer to the buffer cell B61 of FIG. 5) and a clock gating cell (refer to the clock gating cell C61 of FIG. 5). The buffer cell may generate an output signal by performing inverting amplification or non-inverting amplification on an input signal. The clock gating cell may generate an output signal by amplifying an input signal in response to an activated enable signal, or may not amplify the input signal in response to an inactivated enable signal, e.g., may generate an inactivated output signal. To decrease power consumption in an operating mode or a low-power mode of the integrated circuit, the clock gating cell may be used to block a clock signal supplied to a disabled block. An example of the clock network will be described below with reference to FIG. 5.

In operation S310, logic synthesis may be performed to generate netlist data D33 from register-transfer level (RTL) data D31. For example, as a non-limited example, a semiconductor designing tool (e.g., a logic synthesis tool) may perform logic synthesis on the RTL data D31, based on the cell library D32, the RTL data D31 being generated by VHSIC Hardware Description Language (VHDL) and Hardware Description Language (HDL) such as Verilog, and then may generate the netlist data D33 including a bitstream or a netlist. The netlist data D33 may be referred to as data that defines the integrated circuit. As illustrated in FIG. 3, operation S310 may include operation S312, and in operation S312, clock tree synthesis (CTS) may be performed.

The CTS may be performed after function blocks are synthesized based on the RTL data D31. In some embodiments, before the CTS, i.e., when the function blocks are synthesized, an operation of estimating power consumption of the clock network may be performed in operation S330, and the function blocks may be synthesized based on the estimated power consumption. For example, in operation S330, the power consumption of the clock network may be estimated based on a pre-CTS netlist and at least one parameter. In some embodiments, after the CTS is completed, an operation of estimating power consumption of the synthesized clock network may be performed in operation S330. For example, in operation S330, the power consumption of the clock network may be estimated based on a post-CTS netlist. Although not illustrated in FIG. 3, in some embodiments, when the operation of estimating power consumption of the clock network is performed in operation S330, the cell library D32 may be referred thereto.

In operation S320, place & routing (P&R) may be performed, in which layout data D34 is generated from the netlist data D33. For example, a semiconductor designing tool (e.g., a P&R tool) may generate the layout data D34 from the netlist data D33 by placing and routing cells based on the cell library D32 which defines layouts of cells. In some embodiments, the P&R tool may be referred to as a layout data generator. The layout data D34 may have a format such as GDSII, and may include geometric information of cells and wires that electrically interconnect the cells. Accordingly, similar to the netlist data D33, the layout data D34 may be referred to as data that defines the integrated circuit. In some embodiments, in a process of placing and routing the cells included in the clock network, operation S330 of estimating power consumption of the clock network may be performed. For example, the power consumption of the clock network may be estimated based on load capacitances due to the wires generated according to routing.

In operation S340, optical proximity correction (OPC) may be performed. The OPC may refer to an operation of forming a desired pattern by correcting distortion such as refraction due to a characteristic of light in a photolithography process included in a semiconductor process of manufacturing the integrated circuit. Data for making at least one mask may be extracted from the layout data D34, and a pattern on a mask may be determined by applying the OPC to the extracted data. In some embodiments, a layout of the integrated circuit may be limitedly modified in operation S340. To limitedly modify the layout of the integrated circuit in operation S340 corresponds to post-processing for optimizing a structure of the integrated circuit, and may be referred to as design polishing.

In operation S350, an operation of making a mask may be performed. For example, patterns on the mask to form patterns of a plurality of layers may be defined by applying the OPC to the layout data D34, and at least one mask (or a photomask) to form each of the patterns of the plurality of layers may be made.

In operation S360, an operation of manufacturing the integrated circuit may be performed. For example, the integrated circuit may be manufactured by patterning the plurality of layers by using the at least one mask made in operation S350. As illustrated in FIG. 3, operation S360 may include operations S361 and S362.

In operation S361, a front-end-of-line (FEOL) process may be performed. The FEOL process may refer to a process of forming individual elements including a transistor, a capacitor, a resistor, or the like on a substrate in the process of manufacturing the integrated circuit. For example, the FEOL process may include planarizing and cleaning a wafer, forming a trench, forming a well, forming a gate line, forming a source and drain, or the like. Parts that are formed via the FEOL process may be referred to as FEOL regions, and for example, the FEOL regions may include an active region, a diffusion region, the gate line, contacts, or the like.

In operation S362, a back-end-of-line (BEOL) process may be performed. The BEOL process may refer to a process of interconnecting the individual elements including the transistor, the capacitor, the resistor, or the like in the process of manufacturing the integrated circuit. For example, the BEOL process may include performing silicidation of gate, source, and drain regions, adding a dielectric, performing planarization, forming a hole, adding a metal layer, forming a via, forming a passivation layer, or the like. Parts that are formed via the BEOL process may be referred to as BEOL regions, and for example, the BEOL regions may include the via, a metal layer pattern, or the like. Afterward, the integrated circuit may be packaged in a semiconductor package, and may be used as a part of various applications.

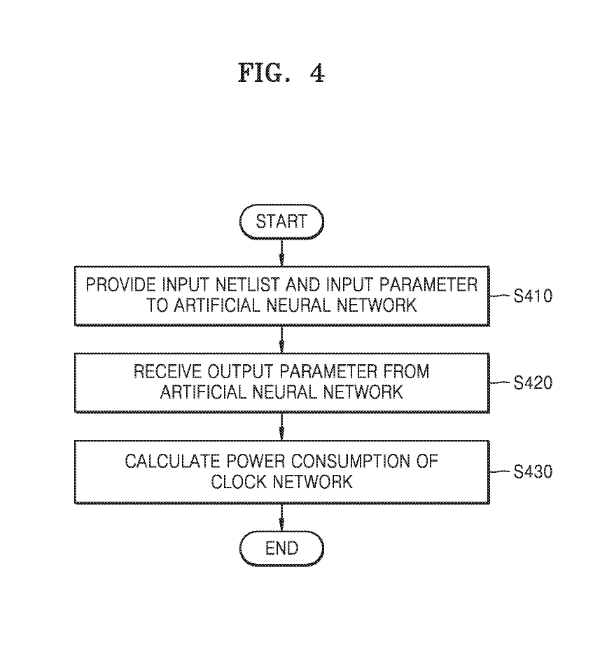

FIG. 4 is a flowchart illustrating a method of estimating power consumption of a clock network, according to an exemplary embodiment. As illustrated in FIG. 4, the method of estimating power consumption of a clock network may include a plurality of operations S410, S420, and S430. In some embodiments, the plurality of operations S410, S420, and S430 in FIG. 4 may be included in operation S330 of FIG. 3, and may be performed by the apparatus 100 of FIG. 1. Hereinafter, FIG. 4 will be described with reference to FIG. 1.

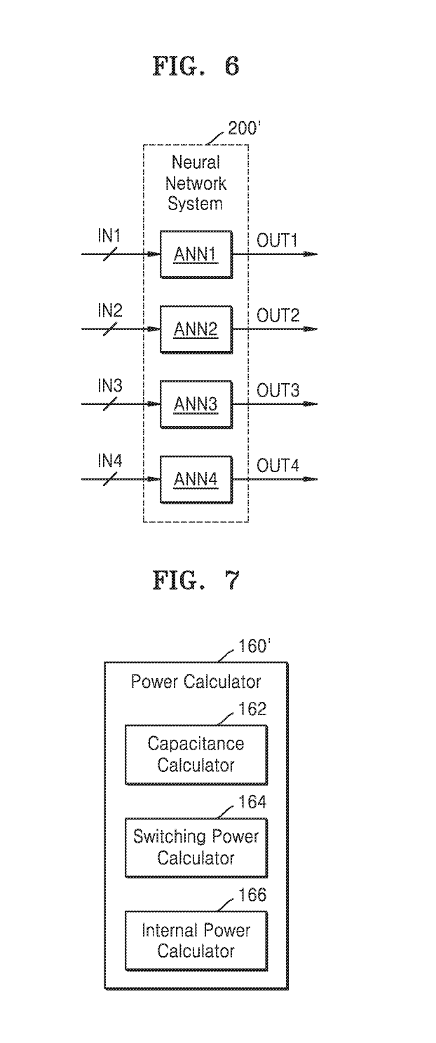

In operation S410, an operation of providing an input netlist and an input parameter to an ANN may be performed. For example, the preprocessor 140 of the apparatus 100 may obtain the input netlist and the input parameter, and may provide input data IN including the input netlist and the input parameter to the at least one ANN of the neural network system 200 via the neural network interface 120. Examples of the input netlist and the input parameter provided to the ANN will be described below with reference to FIGS. 5 and 6.

In operation S420, an operation of receiving an output parameter from the ANN may be performed. The output parameter may include a value generated in response to the input netlist and the input parameter in operation S410. For example, the neural network interface 120 may receive output data OUT, which corresponds to the input data IN provided in operation S410, from the at least one ANN of the neural network system 200, and may provide the output data OUT to the power calculator 160. An example of the output parameter provided from the ANN will be described below with reference to FIGS. 5 and 6.

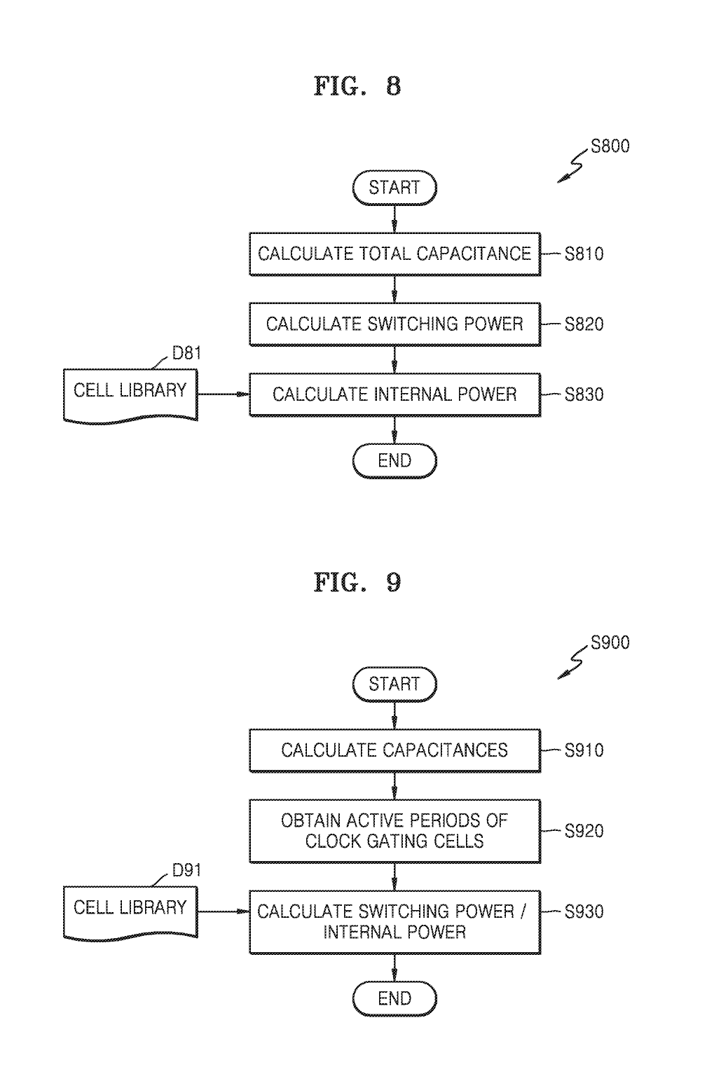

In operation S430, an operation of calculating power consumption of the clock network may be performed. For example, the power calculator 160 may calculate the power consumption of the clock network, based on information obtained by the preprocessor 140, the information including at least some of the input netlist and the input parameter and the output parameter. In some embodiments, the power calculator 160 may calculate the power consumption of the clock network by calculating each of power consumption resulting from a buffer cell and power consumption resulting from a clock gating cell, the buffer cell and the clock gating cell being included in the clock network. In some embodiments, the power calculator 160 may calculate the power consumption of the clock network by calculating switching power of the clock network and internal power of each of cells included in the clock network. An example of operation S430 will be described below with reference to FIGS. 8 and 9.

FIG. 5 is a diagram illustrating an example of a clock network, according to an exemplary embodiment. Referring to FIG. 5, the clock network may include a clock generator 61, a plurality of buffers B61 to B64 (also referred to as the first to fourth buffer cells B61 to B64), a plurality of clock gating cells C61 and C62 (also referred to as the first and second clock gating cells C61 and C62), and a plurality of sinks S61 to S64 (also referred to as the first to fourth sinks S61 to S64). The clock network may have a tree structure as illustrated in FIG. 5, and may be referred to as a clock tree. A component of a lowermost level in the clock tree, i.e., the plurality of sinks S61 to S64, may refer to cells such as flip-flops or latches to receive a clock signal. The clock network of FIG. 5 corresponds to an example for describing exemplary embodiments of the present disclosure, but the exemplary embodiments of the present disclosure are not limited to the clock network of FIG. 5.

The clock generator 61 may generate a clock signal that is constant or oscillates with a variable cycle. For example, the clock generator 61 may include at least one of an oscillator, a phase-locked loop (PLL), and a delayed-locked loop (DLL). The clock signal generated by the clock generator 61 may pass through different paths until the clock signal reaches the plurality of sinks S61 to S64, such that the clock signal may be differently delayed. Also, the clock signal may be distorted due to various causes. To compensate for the delay and the distortion of the clock signal, the clock network may include the plurality of buffers B61 to B64 and the plurality of clock gating cells C61 and C62, and the plurality of buffers B61 to B64 and the plurality of clock gating cells C61 and C62 may be defined in a cell library (e.g., the cell library D32 of FIG. 3).

The plurality of buffers B61 to B64 may amplify the clock signal received from a component of an upper level, and then may provide the clock signal to a component of a lower level. When power is supplied to the integrated circuit and the clock signal is being generated by the clock generator 61, the plurality of buffers B61 to B64 may perform non-inverting amplification or inverting amplification on the clock signal.

The plurality of clock gating cells C61 and C62 may respectively receive first and second enable signals EN1 and EN2. For example, the first clock gating cell C61 may receive the first enable signal EN1, may amplify a clock signal received from the first buffer cell B61, in response to the activated first enable signal EN1, and then may provide the amplified clock signal to the first sinks S61. In response to the inactivated first enable signal EN1, the first clock gating cell C61 may provide a signal having a constant level (e.g., a low level) to the first sinks S61, regardless of the clock signal received from the first buffer cell B61. Accordingly, when the first enable signal EN1 becomes inactivated, power consumption at the first sinks S61 due to transition of the clock signal may be decreased. In addition, because the first clock gating cell C61 does not amplify the clock signal, in response to the inactivated first enable signal EN1, power consumption at the first clock gating cell C61 may also be decreased. Accordingly, power consumption of the clock network may depend on whether clock gating cells are enabled, and as will be described below, active periods in which the clock gating cells are enabled are obtained by simulating the integrated circuit and the power consumption of the clock network may be accurately calculated based on the obtained active periods.

FIG. 6 is a block diagram illustrating an example of the neural network system 200 of FIG. 1, according to an exemplary embodiment. As illustrated in FIG. 6, a neural network system 200′ may include first to fourth ANNs ANN1 to ANN4, and as described above with reference to FIG. 1, each of the first to fourth ANNs ANN1 to ANN4 may be trained by a plurality of netlists and a plurality of parameters which correspond to a plurality of sample clock networks. Hereinafter, FIG. 6 will now be described with reference to the clock network of FIG. 5.

The first ANN ANN1 may generate first output data OUT1 from first input data IN1. For example, the first input data IN1 may include a parameter (a first input parameter) including at least one of a target skew of the clock network, a sink transition time constraint, an area, a utilization factor, an aspect ratio, and the number of sinks of a clock gating cell. Also, the first input data IN1 may include the number of clock gating cells in an input netlist. The target skew may correspond to skew requirements of clock signals provided by the clock network. The sink transition time constraint may correspond to transition time (e.g., ascending time and descending time) of a clock signal which is required for an input of sinks of the clock network. The area, the utilization factor, and the aspect ratio may respectively correspond to physical requirements required to implement the clock network in the integrated circuit. The number of sinks of a clock gating cell may correspond to the number of sinks to be clock gated by one clock gating cell.

The first output data OUT1 may include the number of clock gating cells, and the number of clock gating cells included in the first output data OUT1 may be an estimated number of clock gating cells included in the clock network. Because the first ANN ANN1 has been trained based on the first input data IN1 and the first output data OUT1 which correspond to the plurality of sample clock networks, the first ANN ANN1 may generate the first output data OUT1 according to the first input data IN1 corresponding to the clock network.

The second ANN ANN2 may generate second output data OUT2 from second input data IN2. For example, the second input data IN2 may include a parameter (a second input parameter) including at least one of the target skew of the clock network, the sink transition time constraint, a buffer transition time constraint, the area, the utilization factor, the aspect ratio, and an average of the number of sinks of clock gating cells. Also, the second input data IN2 may include the estimated number of clock gating cells included in the first output data OUT1. The second output data OUT2 may include the number of buffer cells, and the number of buffer cells included in the second output data OUT2 may be an estimated number of buffer cells included in the clock network. Because the second ANN ANN2 has been trained based on the second input data IN2 and the second output data OUT2 which correspond to the plurality of sample clock networks, the second ANN ANN2 may generate the second output data OUT2 according to the second input data IN2 corresponding to the clock network.

The third ANN ANN3 may generate third output data OUT3 from third input data IN3. For example, the third input data IN3 may include a parameter (a third input parameter) including at least one of the sink transition time constraint, the buffer transition time constraint, the area, the utilization factor, and the aspect ratio. Also, the third input data IN3 may include the estimated number of clock gating cells included in the first output data OUT1, and the estimated number of buffer cells included in the second output data OUT2. The third ANN ANN3 may have been trained based on the third input data IN3 and the third output data OUT3 which correspond to the plurality of sample clock networks, such that the third ANN ANN3 may generate the third output data OUT3 according to the third input data IN3 corresponding to the clock network.

The fourth ANN ANN4 may generate fourth output data OUT4 from fourth input data IN4. For example, the fourth input data IN4 may include a parameter (a fourth input parameter) including at least one of the sink transition time constraint, the buffer transition time constraint, the area, the utilization factor, and the aspect ratio. Also, the fourth input data IN4 may include the estimated number of clock gating cells included in the first output data OUT1. The fourth ANN ANN4 may have been trained based on the fourth input data IN4 and the fourth output data OUT4 which correspond to the plurality of sample clock networks, such that the fourth ANN ANN4 may generate the fourth output data OUT4 according to the fourth input data IN4 corresponding to the clock network.

FIG. 7 is a block diagram illustrating an example of the power calculator 160 of FIG. 1, according to an exemplary embodiment. As described above with reference to FIG. 1, a power calculator 160′ of FIG. 7 may calculate power consumption of the clock network, based on the output data OUT received from the neural network interface 120 of FIG. 1. As illustrated in FIG. 7, the power calculator 160′ may include a capacitance calculator 162, a switching power calculator 164, and an internal power calculator 166. Hereinafter, FIG. 7 will now be described with reference to the clock network of FIG. 5.

The capacitance calculator 162 may calculate capacitances of cells included in the clock network. In the present specification, capacitance of a cell included in the clock network may include capacitance that a clock signal output from a cell experiences. For example, capacitance of the first buffer cell B61 of FIG. 5 may include capacitance of a wire that interconnects the first buffer cell B61 and the first clock gating cell C61; an input capacitance of the first clock gating cell C61; capacitance of a wire that interconnects the first buffer cell B61 and the third buffer cell B63; and an input capacitance of the third buffer cell B63. The capacitances calculated by the capacitance calculator 162 may be provided to the switching power calculator 164 and the internal power calculator 166.

In some embodiments, the capacitance calculator 162 may calculate a total capacitance of buffer cells included in the clock network. As described above with reference to FIG. 5, the buffer cells may amplify the clock signal while the clock signal is being provided, thus, power consumption of the buffer cells, e.g., switching power and internal power may always occur. Accordingly, the total capacitance of the buffer cells included in the clock network may be used to calculate the power consumption of the buffer cells. For example, a total capacitance C_BUF_{TOT} of the buffer cells may be calculated by using Equation 1 below.

C_BUF_{TOT}=C_BUF_{WIRE}+C_BUF_{IN}+C_CGC_{IN}+C_SINK_{IN} [Equation 1]

In Equation 1, C_BUF_{WIRE} indicates wire load capacitances of the buffer cells, C_BUF_{IN} indicates input capacitances of the buffer cells, C_CGC_{IN} indicates input capacitances of clock gating cells, and C_SINK_{IN} indicates an input capacitance of a sink.

In some embodiments, the capacitance calculator 162 may calculate capacitance of each of the clock gating cells included in the clock network. As described above with reference to FIG. 5, the clock gating cells may selectively amplify the clock signal, in response to enable signals, thus, in some embodiments, the capacitance of each of the clock gating cells may be individually calculated. For example, capacitance C_CGC1 of the first clock gating cell C61 of FIG. 5 may be calculated by using Equation 2 below.

C_CGC1=N_SINK_{CGC1}×C_SINK_{IN}+C_CGC1_{WIRE} [Equation 2]

In Equation 2, N_SINK_{CGC1} indicates the number of the first sinks S61 that are sinks to which a clock signal is supplied from the first clock gating cell C61, C_SINK_{IN} indicates an input capacitance of a sink, and C_CGC1_{WIRE} indicates a wire load capacitance of the first clock gating cell C61, i.e., capacitance of a wire that interconnects the first clock gating cell C61 and the first sinks S61.

In some embodiments, it is assumed that each of clock gating cells included in the clock network may have a same capacitance, therefore, calculation complexity may be decreased. For example, capacitance C_CGC of a clock gating cell may be calculated by using Equation 3 below.

C_CGC=AVG(N_SINK_{CGC})×C_SINK_{IN}+(C_CGC_{TOT}/N_CGC) [Equation 3]

In Equation 3, AVG(N_SING_{CGC}) indicates an average of the number of sinks to which a clock signal is supplied from each of the clock gating cells, C_CGC_{TOT} indicates a total wire load capacitances of the clock gating cells, and N_CGC indicates the number of the clock gating cells included in the clock network.

The switching power calculator 164 may calculate switching power of the clock network. In some embodiments, the switching power calculator 164 may calculate the switching power of the clock network, based on the capacitances calculated by the capacitance calculator 162. For example, in a case where capacitance of a cell of the clock network is C and a positive voltage supply supplied to the cell is V, switching power P_{S} due to the cell may be calculated by using Equation 4 below.

P_{S}=C·V²·f [Equation 4]

In Equation 4, f indicates a frequency of a clock signal. Accordingly, switching power P_BUFs due to the buffer cells may be calculated by using Equation 5 below.

P_BUF_{S}=C_BUF_{TOT}·V²·f [Equation 5]

As described above with reference to FIG. 5, power consumption due to a clock gating cell may depend on an enable signal. In some embodiments, the switching power calculator 164 may obtain information about an active period in which the clock gating cell is enabled, from a result achieved by functionally simulating the integrated circuit. For example, switching power P_CGC1s due to the first clock gating cell C61 may be calculated by using Equation 6 below.

$${P}_{CGC {1}_{s}} = \{ \begin{matrix}C\_CGC 1 \cdot {V}^{2} \cdot f & ( C 61 is enabled ) \\ 0 & ( C 61 is disabled )\end{matrix} \qquad [ Equation 6 ]$$

In some embodiments, when a ratio of the active period of the first clock gating cell C61, i.e., a period in which the first enable signal EN1 is activated, to a certain period is r1, the switching power P_CGC1s due to the first clock gating cell C61 may be calculated by using Equation 7 below.

P_CGC1^{S}=r1·C_CGC1·V²·f [Equation 7]

In some embodiments, C_CGC1 of [Equation 6] and [Equation 7] may be replaced by C_CGC of [Equation 3].

The internal power calculator 166 may calculate internal power that is power consumed by cells of the clock network. In some embodiments, the internal power calculator 166 may refer to a cell library defining the cells of the clock network, and the cell library may include information about internal power of a cell. For example, the cell library may define internal power corresponding to various conditions. For example, the cell library may include a lookup table including indexes of transition time of an input signal, a load capacitance of a cell, and internal power, and may define a function whose factors are the transition time of the input signal and the load capacitance of the cell. In some embodiments, the internal power calculator 166 may receive target transition time (or a transition time constraint) of a clock signal from the preprocessor 140 of FIG. 1, and may use the target transition time as transition time of an input signal to calculate the internal power of the cell. Also, the power calculator 160 may use the load capacitance of the cell from among the capacitances calculated by the capacitance calculator 162. Accordingly, the internal power calculator 166 may calculate internal power of each of the cells included in the clock network.

Similar to the switching power calculator 164, the internal power calculator 166 may obtain the information about the active period in which the clock gating cell is enabled, from the result achieved by functionally simulating the integrated circuit. Accordingly, internal power P_CGC1_{I} due to the first clock gating cell C61 in a certain period may be calculated by using Equation 8 below.

P_CGC1ᵢ=r1·P_CGC_{REF} [Equation 8]

In Equation 8, P_CGC_{REF} may indicate internal power of the enabled first clock gating cell C61, the internal power being obtained based on the cell library. Power of the clock network may be calculated by summing the switching power calculated by the switching power calculator 164 and the internal power calculated by the internal power calculator 166.

FIGS. 8 and 9 are flowcharts illustrating methods of calculating power consumption of a clock network, according exemplary embodiments. In more detail, FIG. 8 illustrates an example of calculating power consumption of buffer cells included in the clock network, and FIG. 9 illustrates an example of calculating power consumption of clock gating cells included in the clock network. The power consumption of the clock network may be calculated by summing the power consumption of the buffer cells calculated in operation S800 of FIG. 8 and the power consumption of the clock gating cells calculated in operation S900 of FIG. 9. For example, operation S800 of FIG. 8 and operation S900 of FIG. 9 may be performed by the power calculator 160 of FIG. 1. Hereinafter, descriptions of FIGS. 8 and 9 which are redundant to what is described above may not be provided herein.

Referring to FIG. 8, operation S800 involving calculating the power consumption of the buffer cells may include a plurality of operations S810, S820, and S830. In operation S810, an operation of calculating a total capacitance of the buffer cells may be performed. As described above with reference to FIGS. 5 and 7, because the buffer cells may amplify a clock signal while the clock signal is being provided, power consumption due to the buffer cells may always occur, such that the total capacitance of the buffer cells may be used to calculate the power consumption of the buffer cells. For example, the total capacitance of the buffer cells may be calculated by using Equation 1.

In operation S820, an operation of calculating switching power of the buffer cells may be performed. For example, the switching power of the buffer cells may be calculated by using Equation 4, based on the total capacitance calculated in operation S810, a positive voltage supply, and a frequency of a clock signal.

In operation S830, an operation of calculating internal power of the buffer cells may be performed based on a cell library D81. The cell library D81 may include information about internal power of each of the buffer cells, and the internal power of each of the buffer cells may be calculated by using a factor that determines internal power, the factor including transition time of an input signal and a load capacitance of a buffer cell. Accordingly, the power consumption of the buffer cells of the clock network may be calculated by summing the switching power of the buffer cells calculated in operation S820 and the internal power of each of the buffer cells calculated in operation S830.

Referring to FIG. 9, operation S900 involving calculating power consumption of clock gating cells may include a plurality of operations S910, S920, and S930. In operation S910, an operation of calculating capacitances of the clock gating cells may be performed. As described above with reference to FIGS. 5 and 7, each of the clock gating cells may selectively amplify a clock signal, in response to enable signals, therefore, capacitance of each of the clock gating cells may be calculated. For example, capacitance of each clock gating cell may be calculated by using Equation 2. In some embodiments, it is assumed that each of the clock gating cells included in the clock network may have a same capacitance, and for example, the capacitances of the clock gating cells may be equally calculated by using Equation 3.

In operation S920, an operation of obtaining active periods of the clock gating cells may be performed. For example, an integrated circuit including the clock network may be functionally simulated and then a result of simulating enable signals input to the clock gating cells may be obtained. An active period of a clock gating cell enabled in response to an activated enable signal may be obtained, and respective active periods of the clock gating cells may be equal to or different from each other. As described above, power consumption of the clock gating cells is calculated based on the active periods of the clock gating cells, therefore, power consumption of the clock network may be accurately estimated.

In operation S930, an operation of calculating switching power and internal power of the clock gating cells by referring to a cell library D91 may be performed. The switching power and the internal power of each clock gating cell may occur in the active period obtained in operation S920, such that the switching power and the internal power of the clock gating cells in a given period may be accurately estimated. For example, the switching power of each clock gating cell may be calculated by using Equations 6 and 7, based on the active period obtained in operation S920, the capacitance of each clock gating cell calculated in operation S910, a positive voltage supply, and a frequency of a clock signal. The internal power of each clock gating cell may be calculated by referring to the cell library D91. For example, the internal power of each clock gating cell may be calculated by using Equation 8, based on the active period obtained in operation S920 and the internal power of the enabled first clock gating cell C61. Accordingly, in operation S930, the calculated switching power and the calculated internal power of each of the clock gating cells are summed, such that the power consumption of the clock gating cells of the clock network may be calculated.

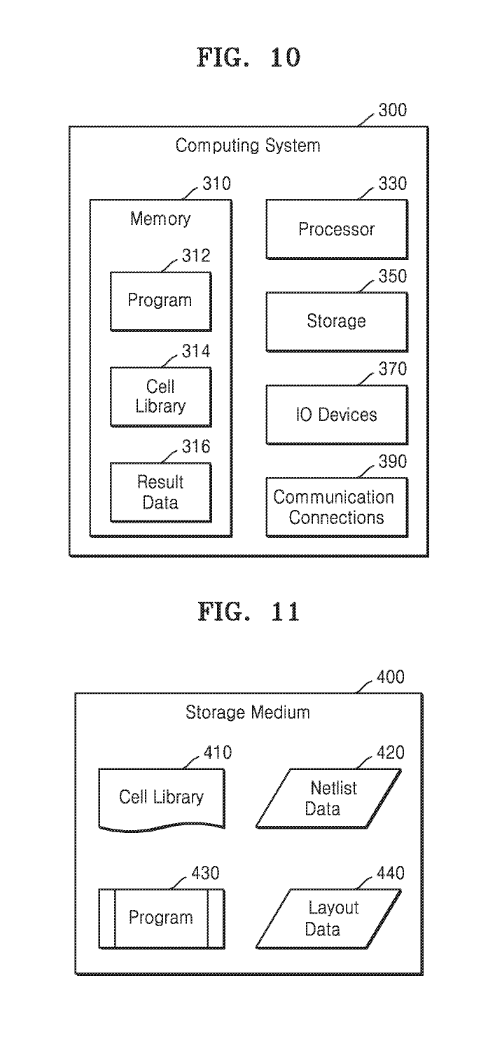

FIG. 10 is a block diagram of a computing system 300, according to an exemplary embodiment. In some embodiments, the apparatus 100 of FIG. 1 may be implemented as the computing system 300 of FIG. 10. As illustrated in FIG. 10, the computing system 300 may include a memory 310 (also referred to as the system memory 310), a processor 330, a storage 350, input and output (10) devices 370, and communication connections 390. Components included in the computing system 300 may be interconnected for communication via a bus.

The memory 310 may include a program 312, a cell library 314, and result data 316. In some embodiments, the program 312, the cell library 314, and the result data 316 may be stored in the storage 350, and at least some of the program 312, the cell library 314, and the result data 316 stored in the storage 350 may be loaded to the memory 310. As a non-limited example, the memory 310 may include a volatile memory such as a static random access memory (SRAM) or a dynamic random access memory (DRAM), or may include a non-volatile memory such as a flash memory, or the like.

The program 312 may cause the processor 330 to perform at least some of operations of the method for manufacturing an integrated circuit according to the exemplary embodiments. For example, the program 312 may include a plurality of instructions executable by the processor 330, and when the plurality of instructions included in the program 312 are executed by the processor 330, at least some of the method for manufacturing an integrated circuit may be performed.

The cell library 314 may include information that defines cells included in the integrated circuit, and for example, the cell library 314 may include information about a buffer cell and a clock gating cell included in a clock network. The program 312 may perform at least some of the method for manufacturing an integrated circuit, based on the information included in the cell library 314.

The result data 316 may receive data processed by the processor 330 and/or data received from an outer source of the computing system 300. For example, the result data 316 may include at least some of the netlist data D33 and the layout data D34 of FIG. 3. In some embodiments, the result data 316 may include the output data OUT that is provided from the ANN of FIG. 1 and defines the clock network, and may include information about the estimated power consumption of the clock network.

The processor 33—may include at least one core capable of executing a random instruction set (e.g., Intel Architecture-32 (IA-32), 64-bit extension IA-32, x86-64, PowerPC, Scalable Processor Architecture (SPARC), Microprocessor without Interlocked Pipeline Stages (MIPS), Advanced RISC Machine (ARM), IA-64, or the like. The processor 330 may execute the instructions stored in the system memory 310, and may perform at least some of the method for manufacturing an integrated circuit by executing the program 312.

The storage 350 may not lose stored data even if power supplied to the computing system 300 is discontinued. For example, the storage 350 may include a non-volatile memory such as an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or the like, or may include a storage medium such as a magnetic tape, an optical disc, a magnetic disc, or the like. In some embodiments, the storage 350 may be detachable from the computing system 300. In some embodiments, the storage 350 may store a file generated by a program language, and the program 312 or at least some of the program 312 generated from the file by using a compiler may be loaded to the system memory 310.

In some embodiments, the storage 350 may store data to be processed by the processor 330 and/or data processed by the processor 330. For example, the storage 350 may store the input data IN and/or the output data OUT of FIG. 1, and may store data, e.g., the estimated power consumption of the clock network, which is generated when the method for manufacturing an integrated circuit is being performed.

The IO devices 370 may include an input device such as a keyboard, a pointing device, or the like, and may include an output device such as a display device, a printer, or the like. For example, via the IO devices 370, a user may trigger the processor 330 to execute the program 312, may input the input data IN of FIG. 1, and may check the output data OUT of FIG. 1 and/or the estimated power consumption.

The communication connections 390 may provide an access to an external network of the computing system 300. For example, the network may include a plurality of computing systems and communication links, and the communication links may include wired links, optical links, wireless links, or random other links.

FIG. 11 is a block diagram of a storage medium 400, according to an exemplary embodiment. Descriptions about FIG. 11 which are redundant to what is described with respect to FIG. 10 are not provided herein. The storage medium 400 may include a random storage medium that is readable by a computer while the storage medium 400 is being used to provide instructions and/or data to the computer. For example, the storage medium 400 may include a disc, a tape, a magnetic or optical medium such as CD-ROM, DVD-ROM, CD-R, CD-RW, DVD-R, DVD-RW, or the like, a volatile or non-volatile memory such as RAM, ROM, a flash memory, or the like, a non-volatile memory being accessible via a universal serial bus (USB) interface, microelectromechanical systems (MEMS), or the like. The storage medium 400 may be inserted into the computer, may be integrated in the computer, or may be combined with the computer via a communication medium such as a network and/or a wireless link.

Referring to FIG. 11, the storage medium 400 may be a computer-readable non-transitory storage medium including a cell library 410, a netlist data 420, a program 430, and a layout data 440. Referring to FIG. 11, the cell library 410, the netlist data 420, the program 430, and the layout data 440 are stored in one storage medium 400, but in some embodiments, the cell library 410, the netlist data 420, the program 430, and the layout data 440 may be stored in different storage media, respectively.

According to the apparatus and method for manufacturing an integrated circuit according to the exemplary embodiments, the power consumption of the clock network may be accurately estimated with low calculation complexity.

According to the apparatus and method for manufacturing an integrated circuit according to the exemplary embodiments, parameters required to estimate the power consumption of the clock network may be generated from initial information about the clock network by using the ANN, and the power consumption of the clock network may be estimated in an early stage of the method for manufacturing an integrated circuit.

According to the apparatus and method for manufacturing an integrated circuit according to the exemplary embodiments, because the power consumption of the clock network is accurately estimated in the early stage of the method for manufacturing an integrated circuit, time taken to design the integrated circuit may be significantly reduced, and the integrated circuit having an optimal function may be manufactured in early stage.

While this disclosure has been particularly shown and described with reference to preferred embodiments thereof, it will be understood by those of ordinary skill in the art that various changes in form and details may be made therein without departing from the spirit and scope of the disclosure as defined by the appended claims. The preferred embodiments should be considered in descriptive sense only and not for purposes of limitation. Therefore, the scope of the disclosure is defined not by the detailed description of the disclosure but by the appended claims, and all differences within the scope will be construed as being included in the present disclosure.

What is claimed is:

1. An apparatus for manufacturing an integrated circuit comprising a clock network, the apparatus comprising:
a preprocessor configured to obtain at least one input parameter and an input netlist comprising the clock network;
a neural network interface configured to provide the input netlist and the at least one input parameter to at least one artificial neural network (ANN) that has been trained based on a plurality of netlists and a plurality of parameters, and receive, from the at least one ANN, at least one output parameter that defines the clock network, wherein the plurality of netlists and the plurality of parameters correspond to a plurality of sample clock networks; and
a power calculator configured to calculate power consumption of the clock network, based on the at least one output parameter.

2. The apparatus of claim 1, further comprising a layout data generator configured to generate layout data that defines the integrated circuit,
wherein the layout data comprises information about a mask to be used in manufacturing the integrated circuit.

3. The apparatus of claim 1, wherein
the at least one input parameter comprises a first input parameter comprising at least one of a target skew, a sink transition time, an area, a utilization factor, an aspect ratio, and a number of sinks of a clock gating cell, and
the neural network interface is further configured to provide the first input parameter and a number of clock gating cells in the input netlist to a first ANN, and receive, from the first ANN, the at least one output parameter comprising an estimated number of the clock gating cells.

4. The apparatus of claim 3, wherein
the at least one input parameter further comprises a second input parameter comprising at least one of a target skew, a sink transition time constraint, a buffer transition time constraint, an area, an utilization factor, an aspect ratio, and an average of a number of sinks of clock gating cells, and
the neural network interface is further configured to provide the second input parameter and the estimated number of the clock gating cells to a second ANN, and, from the second ANN, the at least one output parameter further comprising an estimated number of buffer cells.

5. The apparatus of claim 4, wherein
the at least one input parameter further comprises a third input parameter comprising at least one of a sink transition time constraint, a buffer transition time constraint, an area, an utilization factor, and an aspect ratio, and
the neural network interface is further configured to provide the third input parameter, the estimated number of the clock gating cells, and the estimated number of the buffer cells to a third ANN, and receive, from the third ANN, the at least one output parameter further comprising estimated wire loads of the buffer cells.

6. The apparatus of claim 3, wherein
the at least one input parameter further comprises a fourth input parameter comprising at least one of a sink transition time constraint, an area, an utilization factor, an aspect ratio, and a number of sinks of a clock gating cell, and
the neural network interface is further configured to provide the fourth input parameter and the estimated number of the clock gating cells to a fourth ANN, and receive, from the fourth ANN, the at least one output parameter further comprising estimated wire loads of the clock gating cells.

7. The apparatus of claim 3, wherein the power calculator comprises:
a capacitance calculator configured to calculate total capacitance of buffer cells and capacitances of clock gating cells of the clock network;
a switching power calculator configured to calculate switching power of the clock network, based on the total capacitance and the capacitances; and
an internal power calculator configured to calculate internal power of the buffer cells and the clock gating cells of the clock network, based on an input transition time, the total capacitance, and the capacitances.

8. The apparatus of claim 7, wherein the switching power calculator is further configured to obtain information about active periods in which the clock gating cells are enabled, from a function simulation result of the integrated circuit, and calculate switching power of each of the clock gating cells, based on the capacitances and the active periods.

9. The apparatus of claim 7, wherein the internal power calculator is further configured to obtain information about active periods in which the clock gating cells are enabled, from a function simulation result of the integrated circuit, and calculate the internal power of the clock gating cells, based on the capacitances and the active periods.

10. A method for manufacturing an integrated circuit comprising a clock network, the method comprising:
providing at least one input parameter and an input netlist comprising the clock network to at least one artificial neural network (ANN) that has been trained based on a plurality of netlists and a plurality of parameters, wherein the plurality of netlists and the plurality of parameters correspond to a plurality of sample clock networks;
receiving, from the at least one ANN, at least one output parameter that defines the clock network; and
calculating power consumption of the clock network, based on the at least one output parameter.

11. The method of claim 10, further comprising:
generating layout data that defines the integrated circuit; and
manufacturing the integrated circuit by using at least one mask made based on the layout data.

12. The method of claim 10, wherein
the at least one input parameter comprises a first input parameter comprising at least one of a target skew, a sink transition time, an area, a utilization factor, an aspect ratio, and a number of sinks of a clock gating cell,
the providing of the input netlist and the at least one input parameter comprises providing the first input parameter and a number of clock gating cells in the input netlist to a first ANN, and
the receiving of the at least one output parameter comprises receiving, from the first ANN, the at least one output parameter comprising an estimated number of the clock gating cells.

13. The method of claim 12, wherein
the at least one input parameter further comprises a second input parameter comprising at least one of a target skew, a sink transition time constraint, a buffer transition time constraint, an area, an utilization factor, an aspect ratio, and an average of a number of sinks of clock gating cells,
the providing of the input netlist and the at least one input parameter further comprises providing the second input parameter and the estimated number of the clock gating cells to a second ANN, and
the receiving of the at least one output parameter further comprises receiving, from the second ANN, the at least one output parameter comprising an estimated number of buffer cells.

14. The method of claim 13, wherein
the at least one input parameter further comprises a third input parameter comprising at least one of a sink transition time constraint, a buffer transition time constraint, an area, an utilization factor, and an aspect ratio,
the providing of the input netlist and the at least one input parameter further comprises providing the third input parameter, the estimated number of the clock gating cells, and the estimated number of the buffer cells to a third ANN, and
the receiving of the at least one output parameter further comprises receiving, from the third ANN, the at least one output parameter comprising estimated wire loads of the buffer cells.

15. The method of claim 12, wherein
the at least one input parameter further comprises a fourth input parameter comprising at least one of a sink transition time constraint, an area, an utilization factor, an aspect ratio, and a number of sinks of a clock gating cell,
the providing of the input netlist and the at least one input parameter further comprises providing the fourth input parameter and the estimated number of the clock gating cells to a fourth ANN, and
the receiving of the at least one output parameter further comprises receiving, from the fourth ANN, the at least one output parameter comprising estimated wire loads of the clock gating cells.

16. The method of claim 10, wherein the calculating of the power consumption comprises calculating power consumption of buffer cells of the clock network,
wherein the calculating of the power consumption of buffer cells comprises:
calculating total capacitance of the buffer cells;
calculating switching power of the buffer cells, based on the total capacitance and a positive voltage supply; and
calculating internal power of the buffer cells, based on the total capacitance and an input transition time.

17. The method of claim 10, wherein the calculating of the power consumption comprises calculating power consumption of clock gating cells of the clock network,
wherein the calculating of the power consumption of the clock gating cells comprises:
calculating capacitances of the clock gating cells;
obtaining active periods in which the clock gating cells are enabled, from a function simulation result of the integrated circuit; and
calculating switching power and internal power of each of the clock gating cells, based on the capacitances and the active periods.

18. A non-transitory computer-readable storage medium storing program instructions which, when executed by at least one processor, perform operations of manufacturing an integrated circuit comprising a clock network, the operations comprising:
providing at least one input parameter and an input netlist comprising the clock network to at least one artificial neural network (ANN) that has been trained based on a plurality of netlists and a plurality of parameters, wherein the plurality of netlists and the plurality of parameters correspond to a plurality of sample clock networks;
receiving, from the at least one ANN, at least one output parameter that defines the clock network; and
calculating power consumption of the clock network, based on the at least one output parameter.

19. The non-transitory computer-readable storage medium of claim 18, wherein the operations further comprise:
generating layout data that defines the integrated circuit; and
extracting data for making at least one mask to be used in the manufacturing of the integrated circuit from the layout data.

20. The non-transitory computer-readable storage medium of claim 18, wherein the calculating of the power consumption of the clock network comprises:
obtaining active periods in which clock gating cells of the clock network are enabled, from a function simulation result of the integrated circuit; and
calculating switching power and internal power of each of the clock gating cells, based on the active periods.
